(19) United States
(12) Patent Application Publication
(10) Pub. No.: US 2008/0172886 A1
(43) Pub. Date: Jul. 24, 2008

(54) Scissors with three axially pivoting and inter-changeable ringlets

(76) Inventor: Dong Ho Jun, Santa Ana, CA (US)

Correspondence Address: Law Offices of Jane Oak & Associates, P.C., Suite 2470, 3435 Wilshire Blvd., Los Angeles, CA, 90010, US

(21) Appl. No.: 11/655,560

(22) Filed: Jan. 19, 2007

(51) Int. Cl. B26B 13/12; B26B 13/00

(52) U.S. Cl. 30/232; 30/252

(57) ABSTRACT

A scissors equipped with a three axially pivoting inter-changeable ringlet is provided. The ringlet of the scissors according to current application is comprised of a flexible NBR (Acrylonitrile Butadiene Rubber) reinforced by a coil spring therein. The ringlet is attached to one handle of the scissors of current application to provide a thumb's insert, thereby providing proper fit to the user's fingers due to the flexibility of the NBR and resiliency of the coil spring. The ringlet is attached to the thumb portion of one handle of the scissor via a part that enables the ringlet rotates in two independent directions and pivots around one axis that is parallel to handle. The ringlet may be applied to both of the handles of a scissor.

### FIELD OF THE INVENTION

Current application relates with a scissors, especially related with a scissors that is equipped with three axially pivoting and inter-changeable ringlets.

### BACKGROUND OF THE INVENTION

Barber, hair dresser, tailor, surgeon and gardener are jobs that use scissors as a main tool. Gardener uses a scissors that is designed to maximize force when cut a branch of a plant. Except the gardener's scissor, other scissors are very similar. Among them barbers use scissor most frequently. In addition to that, they must use their scissors in various positions for convenience of their customer. Therefore, the barber's convenience is sacrificed. After years of practicing as a barber, most of them suffer from gonorrhea on their thumb,and index finger in addition to their vertebra. Most of barbers believe that inconvenient grip of the scissors cause the gonorrhea on their fingers. Some scissors equipped with flexible and rotating ringlets for fingers are introduced. However, most of them do not provide full convenience to the barbers due to the limitation of the rotation and flexibility of ringlets. It is purpose of the current application to provide a scissors that provide full convenience to barbers by enabling ringlet of a scissors rotates and bends in every direction. In addition to that it is another purpose of current invention to provide a scissors equipped with a ringlet that fits to, any finger irrespective of cross-sectional shape of the finger and irrespective of the size.

### DESCRIPTION OF THE PRIOR ART

U.S. Pat. No. 5,125,159 to Brenton, et al. illustrates an interchangeable finger and thumb ringlets equipped scissors. Flexible ringlets having various sizes are removably attached to the handle portions of such instruments, thereby providing proper fit to the user's fingers. It rotates only two directions.

U.S. Pat. No. 4,742,617 to Gauvry illustrates a scissors having an obliquely oriented thumb loop. The thumb loop is oriented approximately 45 degrees downward and 45 degrees laterally with respect to the axis of the handle to which it is attached. The thumb loop also allows for flexible rotational movement of approximately 45 degrees and flexible vertical movement of approximately 45 degrees. The loop is held in position by a flexible connecting member having a flexible intermediate section to allow for the desired movement as well as allowing for return of the thumb loop to the steady state position upon release,

U.S. Pat. No. 4,642,895 to Gauvry illustrates a scissors including a thumb loop means interconnected with respect to the handle of the second member by way of a ball and socket interconnection allowing free movement longitudinally along and perpendicularly around the axis of the second handle. Also, a tab means is included to limit the rotational movement of the thumb means about the ball within the socket itself. The finger loop, not for the thumb, includes removable O-ring means to allow for various size fingers of users. Thumb ringlet of this scissors is made of solid material with limited rotation thereof.

U.S. Pat. No. 4,254,551 to Megna, et al, illustrates a scissors, comprises a movable scissors blade pivotally connected to a stationary scissors blade with a finger bow disposed on the respective stock portions of the blades. At least the finger bow provided at the movable scissors blade is made of synthetic or similar material and is mounted easily rotatable in an outwardly directed edge open recess provided in a finger bow retaining member arranged at the rearward end of the said scissors blade. It has only two directional degree of freedom.

U.S. Pat. No. 2,640,264 to Sullivan, et al., illustrates a scissors having a ringlet for thumb, which is equipped with a thumb guide, positioned on one of the handle thereof. The ringlet is comprised of one outer-ring and one inner-ring. The thumb guide freely rotates with the inner-ring and the ringlet rotates along the axis of the handle for thumb. It has two directional degree of freedom.

U.S. Pat. No. 1,108,572 to Gordon illustrates a cherry clipping scissors, which has a thumb piece pivotally, rotates at the end of a first handle of the scissors. It has only one directional degree of freedom.

U.S. Pat. Nos. 440,436 and 430,677 to Pearsall illustrate shears, which has a thumb support is hinged at the end of a shank for thumb. It has one directional degree of freedom.

None of the prior art illustrates a scissors that enables three axial degree of freedom for thumb ringlet while allow users having various thumb shape.

### SUMMARY OF THE INVENTION

Barber, hair dresser, tailor, surgeon and gardener are jobs that use scissors as a main tool. Gardener uses a different scissors that is designed to maximize force when cut a branch of a plant. Except the gardener's scissor, other scissors are very similar. Among them barbers use scissor most frequently. In addition to this, they must use their scissors in various positions for convenience of their customers. Therefore, the barber's convenience is sacrificed. After years of practicing as a barber, most of them suffer from gonorrhea on their thumb and index finger in addition to their vertebra. Most of barbers believe that inconvenient grip of the scissors cause the gonorrhea on their fingers. Some scissors equipped with flexible and rotating ringlets for fingers are introduced. However, most of them do not provide full convenience to the barbers due to the limitation of the rotation and flexibility of ringlets. It is purpose of the current application to provide a scissors that provide full convenience to barbers by enabling the ringlet of a scissors rotates and bends in every direction. In addition to that it is another purpose of current invention to provide a scissors equipped with a ringlet that fits to any finger irrespective of cross-sectional shape of the finger irrespective of the size of the finger. A scissors equipped with three axially pivoting inter-changeable ringlet is provided. The ringlet of the scissors according to current application is comprised of NBR reinforced by a coil spring therein. The ringlet is attached to the thumb portions of the scissors of the current application, thereby providing proper fit to the user's fingers due to the flexibility of the rubbery plastic and resiliency of the coil spring. The ringlet is attached to the thumb portion of the scissor via a part that enables the ringlet pivots in two independent directions and rotates around an axis that is formed by handle and the ringlet. The ringlet may be applied to both of the handle of a scissor.

### BRIEF DESCRIPTION OF DRAWINGS

FIG. 1 is a schematic drawing of directional degree of freedom of first example of the prior arts.

FIG. 2 is a schematic drawing of directional degree of freedom of second example of the prior arts.

FIG. 3 is a perspective view of third example of the prior arts and a schematic drawing of directional degree of freedom thereof.

FIG. 4 is a schematic drawing showing how the third example of the prior arts is used.

FIG. 5 is an exploded view of a connecting means for the third example of the prior arts that rotatably connects scissors handle and ringlet.

FIG. 6 is a perspective view of a scissors combined with an exploded view of a ringlet and a connecting part for a scissors according to first embodiment of the current application.

FIG. 7 is a perspective view of a scissors combined with an exploded view of a ringlet and a connecting part for a scissors according to second embodiment of the current application.

FIG. 8 is an enlarged perspective view of the ringlet connected to the handle portion of the scissors according to current application.

FIG. 9 is an enlarged perspective view of the ringlet after connected to the handle portion of the scissors according to current application.

FIG. 10 is a perspective view of the scissors according to current application and a schematic drawing of directional degree of freedom thereof.

### DETAILED DESCRIPTION OF THE PREFERRED EMBODIMENT

FIG. 1 is a schematic drawing of directional degree of freedom of one example of the prior arts, U.S. Pat. No. 5,125,159 to Brenton, et al. In FIG. 1, X axis is an axis parallel to the handle of the scissor. Y axis is an axis that is perpendicular to a plane that is formed by two blades of the scissors. Z axis is an axis that is perpendicular to the X axis and the Y axis.

According to Brenton, the ringlet 18 is rotatably attached to extension 16 and is constructed from flexible materials so that additional motion is available to an inserted digit of the user of the device. A handle extension 16 including a tubular section 46 is located at the terminus thereof having its axis disposed in a substantially perpendicular manner to the axis of the handle extension and adapted to receive ringlet 18. Handle extension 16 has a hole 48 bored along the axis thereof in order to enable it to receive the reduced diameter terminus 32 of scissors handle 14 to which it is rigidly attached.

Therefore, the ringlet 18 of '159 rotates freely around the Z axis and X axis of FIG. 1. Slight movement around the Y axis may be possible. But, every movement around the Y axis provides a stress strain to the ringlet 18. Since the ringlet is constructed from flexible materials, repeated stress strain applied to the ringlet 18 will deteriorates physical property of the material and finally breaks it down. If it happens while cutting a customer's hair, it may cause serious damage to the customer.

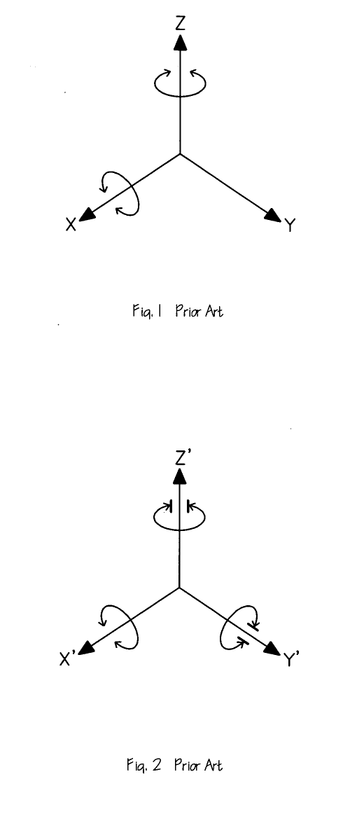

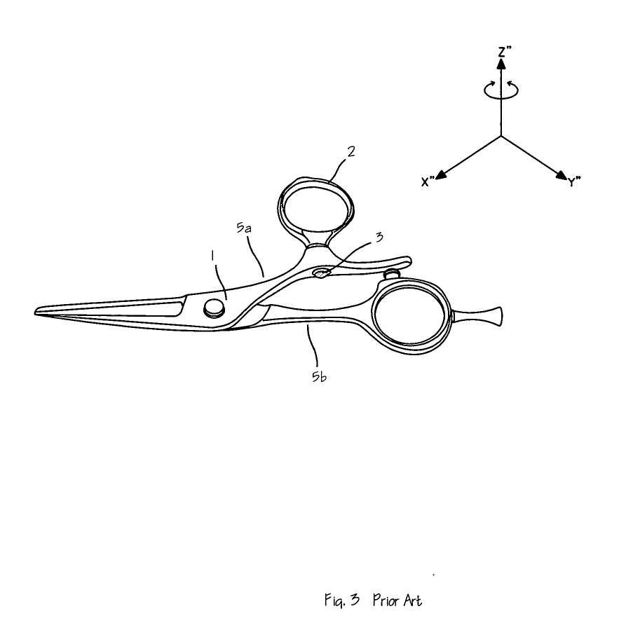

FIG. 2 is a schematic drawing of directional degree of freedom of second example of the prior arts, U.S. Pat. No. 4,642,895 to Gauvry. In FIG. 2, X′ axis is an axis parallel to the handle of the scissor. Y′ axis is an axis that is perpendicular to a plane that is formed by two blades of the scissors. Z′ axis is an axis that is perpendicular to the X′ axis and the Y′ axis.

According to Gauvry, a thumb loop means 28 is mounted on a second handle means 22 by way of a movable interconnecting means 36. It takes the form of a ball means 38 which is fixedly secured with respect to the thumb loop means 28 and a socket means 40 defined within the second handle means 22.

A tap means 50 is positioned therein extending downwardly from the thumb loop means 50 to restrict rotation of the thumb loop.

Therefore, the thumb loop means 28 of '895 rotates freely only around the X′ axis of FIG. 2. The tap means 50 not only restrict the rotation of the thumb loop means 28 around the Z′ axis but also around the Y′ axis due to the long tail of the tap means 50.

FIG. 3 is a perspective view of third example of the prior arts and a schematic drawing of directional degree of freedom thereof. In FIG. 3, X″ axis is an axis parallel to the handle of the scissor. Y″ axis is an axis that is perpendicular to a plane that is formed by two blades of the scissors. Z″ axis is an axis that is perpendicular to the X″ axis and the Y″ axis. The third example is a popular product on market.

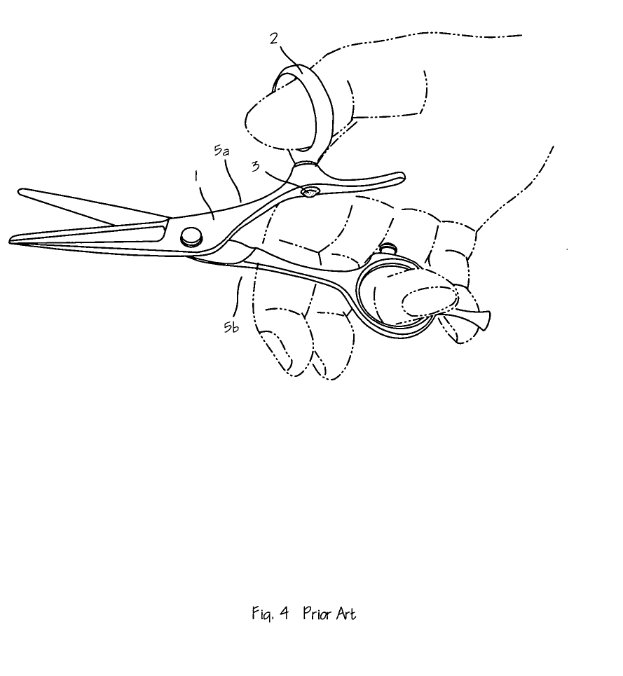

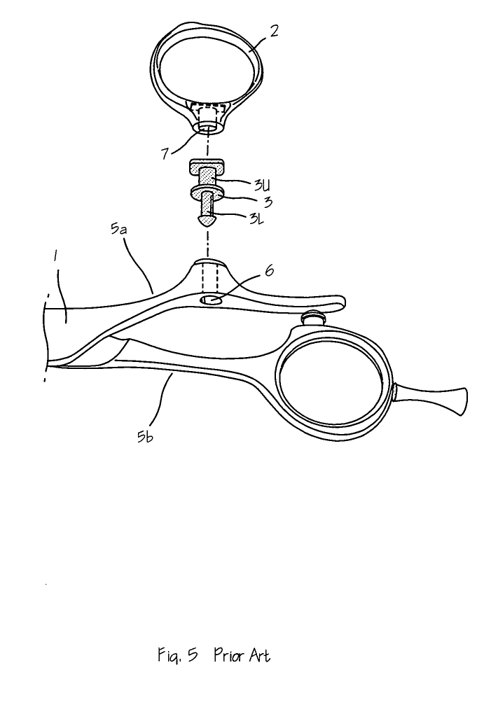

The scissors of third example is comprised of a main body (1) and a ringlet (2). The ringlet (2) is rotatably connected to a handle (5a) of the scissor via a connecting means (3). The ringlet (2) of the scissor in FIG. 3 rotates freely only around the Z″ axis. FIG. 4 is a schematic drawing showing how the third example of the prior arts is used. Thumb of a user is engaged to the ringlet (2).

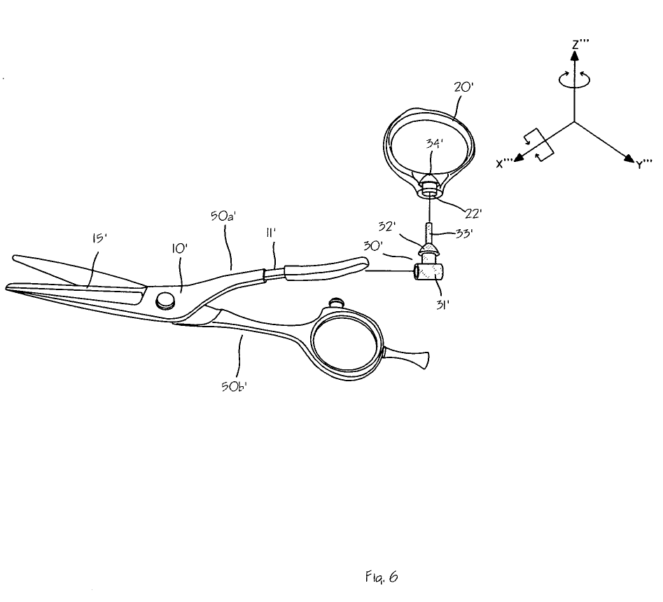

FIG. 5 is an exploded view of a connecting means (3) for the third example of the prior arts that rotatably connect scissors' handle (5A) and ringlet (2). The connecting means (3) is made of a rubbery material. The connecting means (3) has an upper section (3U) and a lower section (3L). The upper section (3U) of the connecting means (3) is engaged to a bore (7) developed on the lower bottom of the ringlet (2) and the lower section (3L) of the connecting mean is engaged to a hole (6) developed on a handle (SA) of the scissor.

Since the ringlet (2) of the third example can rotates freely only around the Z″ axis of the FIG. 3, the inventor try to give some flexibility by applying a rubbery material to the connecting means (3). However, as it is well known that repeated stress to a rubbery material deteriorates physical properties. Therefore, the same danger of cutting the customer's head or skin remains as explained in the first example.

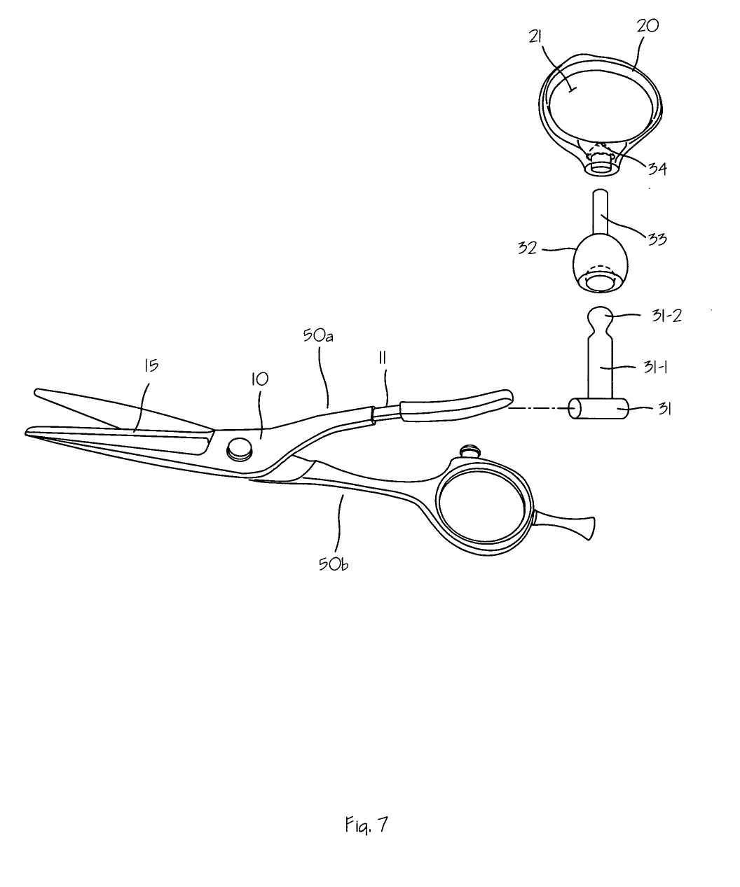

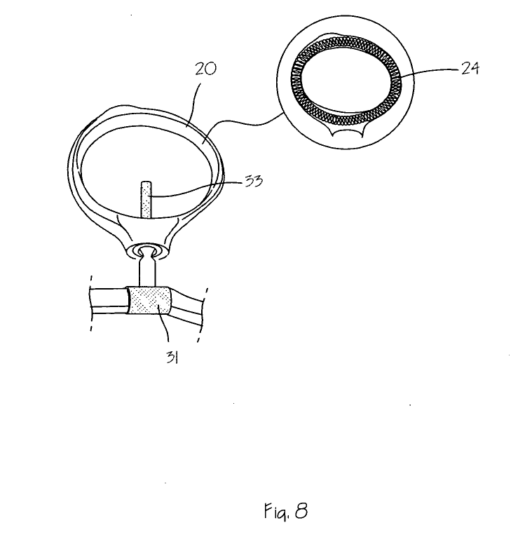

FIG. 6 is a perspective view of a scissors (10′) combined with an exploded view of a ringlet (20′) and-a connecting part (30′) for a scissors according to embodiment of the current application. The scissors (10′) according to current application is comprised of a pair of shank members (14′) including a cutting portion (15′) and handle portion (50a′), (50b′). The shank members (14′) are pivotally connected each other via a screw (16′). A handle portion (50b′) has a solid ringlet (41′). A flexible ringlet (20′) is rotatably connected to the other handle portion (50a′) via a connecting part (30′) that is engaged to a narrow portion (11′) of the handle portion (50a′).

The ringlet (20′) is comprised of a flexible material. A bore (22′) is developed at the bottom of the ringlet (20′) for insertion of the connecting part (39′). The bore (22′) is in a shape of cone on a cylindrical rod and a hole (34′) is developed at the top of the bore (22′).

The connecting part (30′) is comprised of; a conical shape portion (32′) on a cylindrical rod and an extension (33′), to aid the insertion of the conical shape portion (32′) into the bore (22′), and a second part of a tube (31′). The tube (31′) is engaged on the narrow portion (11′) of the handle portion (50a′).

FIG. 7 is a perspective view of a scissors (10) combined with an exploded view of a ringlet (20) and a connecting part (30) for a scissors according to embodiment of the current application. The scissors (10) according to current application is comprised of a pair of shank members (14) including a cutting portion (15) and handle portion (50a), (50b). The shank members (14) are pivotally connected each other via a screw (16). A handle portion (50b) has a solid ringlet (41). A flexible ringlet (20) is rotatably connected to the other handle portion (50a) via a connecting part (30) that is engaged to a narrow portion (11) of the handle portion (50a) by a handle cap (13).

The ringlet (20) is comprised of a flexible out layer (21) reinforced by a coil spring (23). A bore (22) is developed at the bottom of the ringlet (20) for insertion of the connecting part (30). The bore (22) is in a shape of semi-sphere and a hole (34) is developed at the top of the bore (22).

The connecting part (30) is comprised of; a first part of an empty hemi-sphere shaped cover (32) and an extension (33), to aid the insertion of the cover (32) into the bore (22), and a second part of a tube (31) equipped with a vertical protrusion (31-1), which has a spherical top (31-2). The spherical top (31-2) is engaged into the hemi-sphere shaped cover (32). The tube (31) is engaged on the narrow portion (11) of the handle portion (50a) by a handle cap (13).

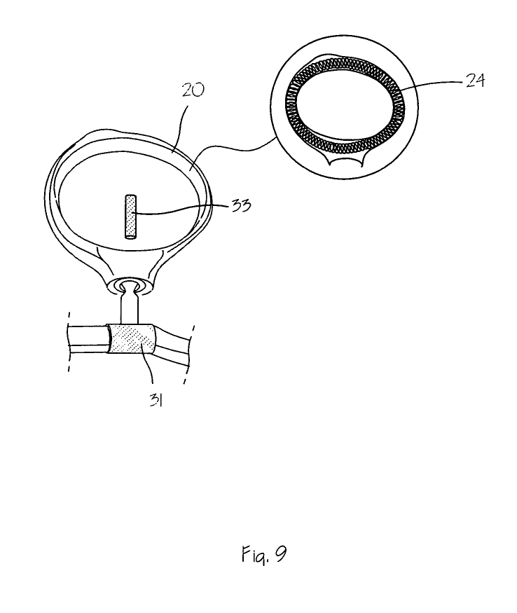

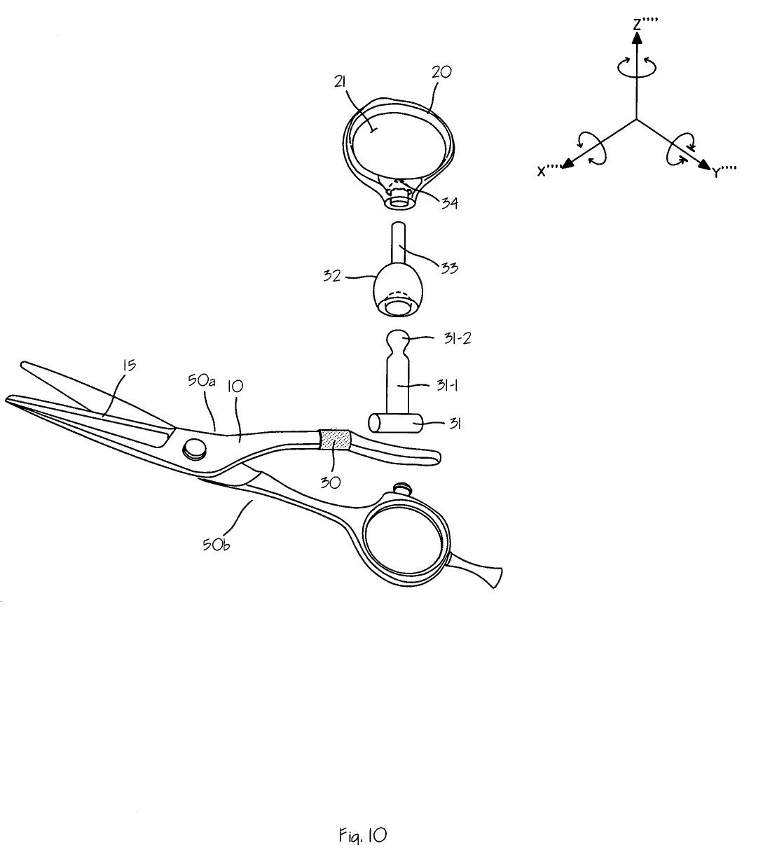

FIG. 8 is an enlarged perspective view of the ringlet (20) connected to the handle portion (50a) of the scissors according to current application. The extension (33) is inserted into the hole (34), which is developed at the top of the bore (22), to aid insertion of the connecting part (30) into the bore (22). The bore is in a shape of semi-sphere on a cylindrical rod. After the connecting part (30) is engaged to the bore (22) of the ringlet (20), the extension (30) is cut away as shown in the FIG. 9. The ringlet (20) is reinforced by a coil spring (24) inside thereof. The coil spring (24) prevents sudden break of the rubbery ringlet (20) due to repeated stress and decay of the rubbery ringlet (20) by sweat of the user or repeated sterilization of the scissors. At the same time, combination of the flexibility of the rubbery ringlet (20) and resiliency of the coil spring (24) therein renders fitness of the ringlet (20) to various sizes and shape of user's thumb. It will release unnecessary pain from thumb of a user though the user's hand position is not appropriate to cut the hair of customer without move the customer. And as a result reduce the risk of getting gonorrhea on the barber's thumb

FIG. 10 is a perspective view of the scissors (10) according to current application and a schematic drawing of directional degree of freedom thereof. The spherical top (31-2) inserted in the hemi-sphere shaped cover (32) enables the ringlet (20) rotate 360 degrees around the Z″ axis. At the same time it allows the ringlet move around the Y″ axis as long as the cover (32) touches the vertical protrusion (31-1) of the tube (31). The tube (31) allows the ringlet turn 360 degrees around the X″ axis. Tight contact of the handle cap (13) to the tube controls the easiness of rotation of the ringlet (20) around the X″ axis.

Combination of the three directional degree of freedom and the metal ring re-enforced rubbery ringlet of the current application provide a scissors for a barber convenient to use and reduce the risk of getting gonorrhea on their thumb. Application of the ringlet according to current application to other finger's ringlet will reduce the risk of gonorrhea on barber's other finger and wrist.

What is claimed is:

1. A scissors with three axially pivoting and inter-changeable ringlets is comprised of:
a pair of shank members including a cutting portion and handle portion and are pivotally connected each other via a screw and a handle portion that has a solid ringlet, and
a flexible ringlet that is rotatably connected to the other handle portion via a connecting part that is engaged to a narrow portion of the handle portion and has a bore, in a shape of cone on a cylindrical rod, developed at the bottom of the ringlet for insertion of the connecting part and has a hole developed at the top of the bore, and
a connecting part that is comprised of;
a conical shape portion on a rod, and
an extension-that aids insertion of the conical shape:portion into the bore, and
a second part of a tube that is engaged on the narrow portion of a handle portion.

2. A scissors with three axially pivoting and inter-changeable ringlets is comprised of:
a pair of shank members including a cutting portion and handle portion and are pivotally connected each other via a screw and a handle portion that has a solid ringlet, and
a flexible ringlet that is comprised of a flexible out layer reinforced by a coil spring and is rotatably connected to the other handle portion via a connecting part that is engaged to a narrow portion of the handle portion by a handle cap and has bore, in a shape of hemi-sphere on a cylindrical rod, developed at the bottom of the ringlet for insertion of a connecting part and a hole is developed at the top of the bore, and
a connecting part that is comprised of;
a first part of an empty hemi-sphere shaped cover, and
an extension that aids the insertion of the cover into the bore, and
a second part of a tube equipped with a vertical protrusion, which has a spherical top that is engaged into the hemi-sphere shaped cover and is engaged on the narrow portion of the handle portion by a handle cap.
